(19) United States
(12) Patent Application Publication
(10) Pub. No.: US 2006/0097933 A1
(43) Pub. Date: May 11, 2006

(54) Slide type mobile terminal

(75) Inventor: Sung-Ho Lee, Suwon-Si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/269,804

(22) Filed: Nov. 9, 2005

(30) Foreign Application Priority Data
Nov. 10, 2004 (KR) 10-2004-091615

(51) Int. Cl. H01Q 1/24

(52) U.S. Cl. 343/702

(57) ABSTRACT

A slide type mobile terminal according to an embodiment of the present invention includes a first body, a second body slidable over the first body in an opening direction to open the mobile terminal, and an antenna configured to move automatically in an outward direction by an operation of sliding the second body over the first body in the opening direction.

This application claims under 35 U.S.C. §119 the priority benefit of Korean Patent Application No. 10-2004-0091615 filed in Republic of Korea on Nov. 10, 2004, the entire contents of which are hereby incorporated by reference.

### BACKGROUND OF THE INVENTION

1. Field of the Invention

The present invention relates to a slide type mobile terminal and, more particularly, to a slide type mobile terminal capable of enhancing speech quality by moving an antenna together with a second body when the second body is relatively slid to be opened/closed over a first body.

2. Description of the Background Art

In general, a mobile terminal includes a flip type mobile terminal having a flip that is rotatably mounted at a terminal body to open/close an input button region, and a folder type mobile terminal which consists of a main body having a dial button and a menu button and a folder rotatably mounted at the man body and having an LCD. Recently, a mobile terminal having a large screen for displaying various information as an image is on demand, and in order to meet the demand, a slide type mobile terminal is increasingly used.

FIG. 1 is a perspective view of a slide type mobile terminal in accordance with a background art.

The slide type mobile terminal as shown in FIG. 1 includes a first body 110 having a key pad 102 mounted at its front surface and allowing a user to input a key and a PCB (not shown) with various circuit components mounted therein; a second body 120 slidably mounted at the front surface of the first body 110 and having an LCD 122 for displaying various types of information; and an antenna 130 mounted at an upper end of the first body 110 and connected with the PCB to transmit/receive radio waves bearing voice and image information to/from the PCB.

A battery 104 is mounted at a rear surface of the first body 110, and the key pad 102 mounted at the front surface of the first body 110 is exposed when the second body 120 is slidably moved upwardly to be opened. The antenna 130 is fixed at the upper end of the first body 110.

A microphone 104 for inputting a voice signal is mounted at a lower end of the first body 110, and a receiver 124 for outputting a voice signal is mounted at an upper end of the second body 120. A sliding unit (not shown) is mounted between the front surface of the first body 110 and a rear surface of the second body 120 in order to allow the second body 120 to be slidably moved on the first body 110.

As for the slide type mobile terminal of FIG. 1, when the second body 120 is slidably moved upwardly on the front surface of the first body 110, the key pad 102 mounted on the first body 110 is exposed to open the mobile terminal.

However, such a slide type mobile terminal has the following problem.

When the second body 120 is slidably moved to open the mobile terminal, the antenna 130 mounted at the upper end of the first body 110 is now positioned completely behind the second body 120 and thus completely hidden (covered) by the second body 120. As a result, a null point is generated in a radiation pattern transmitted to and received from the antenna 130, which degrades the speech quality of the mobile terminal.

### SUMMARY OF THE INVENTION

Therefore, an object of the present invention is to provide a slide type mobile terminal capable of moving an antenna mounted at a first body together with a second body when the second body is slidably moved relatively over the first body in order to prevent the antenna mounted at the first body from being hidden by the second body and thus prevent generation of a null point in a radiation pattern to thereby enhance a speech quality.

Another object of the present invention is to provide a mobile terminal with an extendable and slidable antenna, which overcomes the limitations and disadvantages associated with the background art.

To achieve these and other advantages and in accordance with the purpose of the present invention, as embodied and broadly described herein, there is provided in one aspect a slide type mobile terminal including: a first body having a PCB mounted therein; a second body slidably opened/closed over the first body; and an antenna having a first end disposed to be linearly moved in the PCB and a second end disposed at an upper side of the second body, wherein the antenna is moved along with the second body when the second body is slidably moved.

In one aspect of the present invention, the antenna can include an antenna pole having a certain length; a contact terminal mounted at a lower end of the antenna pole and inserted in a guide groove so as to be slidably moved; and a head mounted at an upper end of the antenna pole and disposed at an upper end of the second body.

In one aspect of the present invention, an auxiliary antenna can be additionally provided at the upper end of the second body and electrically connected with the antenna. The auxiliary antenna can be mounted at a through hole formed at an upper side of the second body and can include a passage through at its central portion to allow the antenna pole to pass therethrough.

According to another aspect of the present invention, there is provided a mobile terminal comprising a first body, a second body slidable over the first body in an opening direction to open the mobile terminal, and an antenna configured to move automatically in an outward direction by an operation of sliding the second body over the first body in the opening direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a slide type mobile terminal in accordance with a background art;

FIG. 2 is a perspective view of a slide type mobile terminal in accordance with an embodiment of the present invention;

FIG. 3 is a perspective view showing an antenna of the slide type mobile terminal of FIG. 2 in accordance with the present invention;

FIG. 4 is a sectional view showing an example of a state that the antenna of the slide type mobile terminal is mounted in accordance with the present invention; and

FIGS. 5 and 6 show examples of the operational states of the antenna of the slide type mobile terminal in accordance with the present invention.

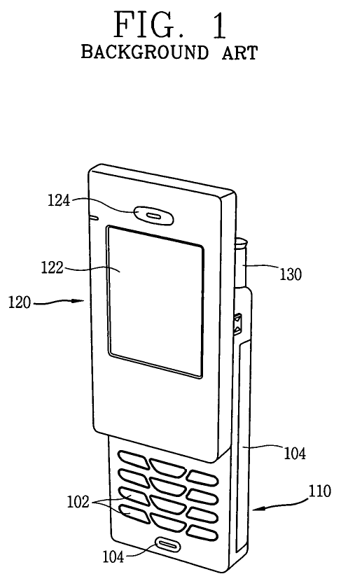

### DETAILED DESCRIPTION OF THE PREFERRED EMBODIMENTS

A slide type mobile terminal in accordance with the preferred embodiments of the present invention will now be described with reference to the accompanying drawings.

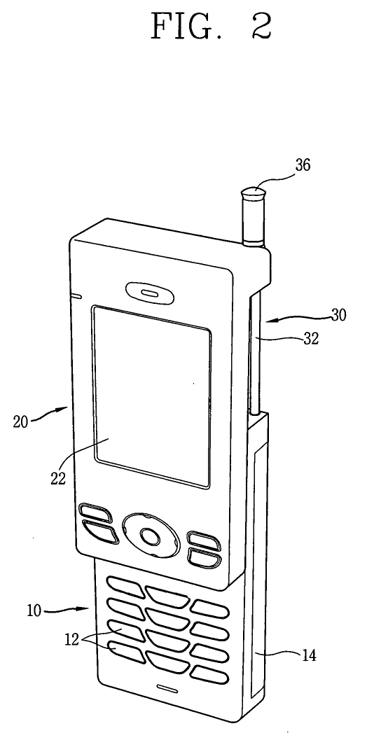

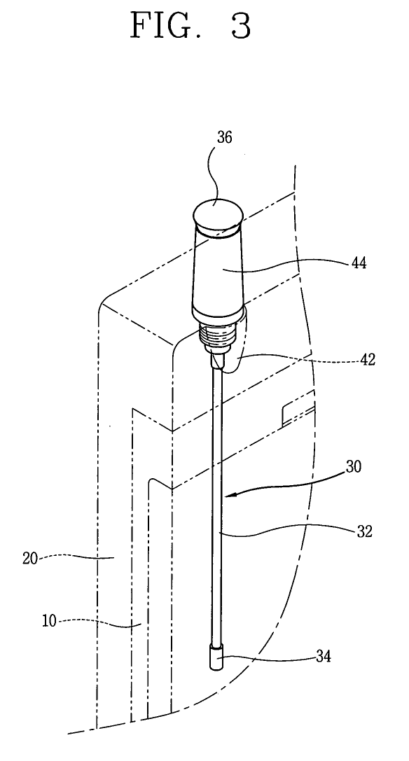

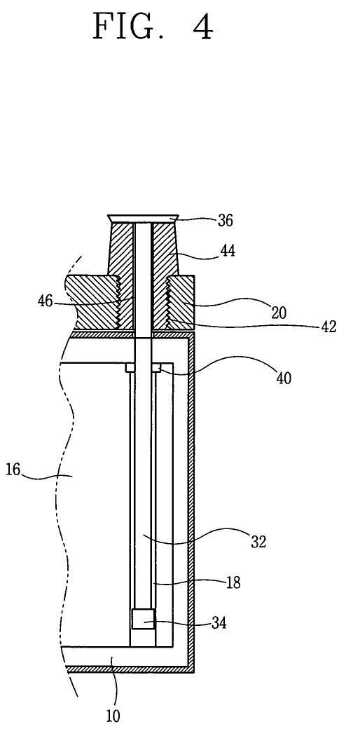

FIG. 2 is a perspective view of a slide type mobile terminal in accordance with the present invention, FIG. 3 is a perspective view showing an antenna of the slide type mobile terminal in accordance with the present invention, and FIG. 4 is a sectional view showing a state that the antenna of the slide type mobile terminal is mounted in accordance with the present invention.

Referring to FIG. 2, the slide type mobile terminal in accordance with an embodiment of the present invention includes a first body 10 having a key pad 12 mounted at its front surface and allowing a user to input information and a battery 14 mounted at its rear surface; a second body 20 slidably mounted at the front surface area of the first body 10 in a longitudinal direction and having an LCD 22 (or other type of display screens) for displaying various images and information; and an antenna 30 mounted to linearly move within the first body 10 and connected with an upper end portion of the second body 20 so as to be moved along with the second body 20.

As shown in FIG. 4, a printed circuit board (PCB) 16 with various circuit components mounted thereon is installed inside the first body 10, and a guide groove 18 is formed in a longitudinal direction of the mobile terminal at the PCB in order to guide the movement of the antenna 30 in a state where a lower end of the antenna 30 is electrically contacted in the guide groove 18.

Referring to FIGS. 3 and 4, the antenna 30 includes an antenna pole 32 having a certain length, transmitting/receiving radio waves bearing voice and/or image information to/from the PCB 16, and having an upper end portion positioned at an upper side portion of the second body 20 and a lower portion positioned inside the first body 10; a contact terminal 34 mounted at a lower end of the antenna pole 32 and configured to slide up and down in a state of being in contact with the guide groove 18 formed in the PCB 16 installed inside the first body 10 such that the contact terminal 34 is in electrical contact with the PCB 16 when it slides within the groove 18; and a head 36 mounted at an upper end of the antenna pole 32 and disposed to be exposed at an upper end of the second body 20. The contact terminal 34 remains in the guide groove 18 at all times. Also, the second body 20 has a through hole 42 (e.g., aligned with the guide groove 18 of the first body 10) through which the antenna pole 32 slides.

The antenna pole 32 is moved automatically together with the second body 20 when the second body 20 is slidably opened (e.g., moved upwardly) so that the antenna 30 is exposed and the second body 20 does not interfere with its antenna operation. The antenna pole 32 has a length so as to be moved longer than a certain length upwardly of the second body 20. In one example, when the second body 20 is slidably opened, the contact terminal 34 mounted at the lower end of the antenna pole 32 is also automatically moved and ends up being positioned approximately in the middle (or middle area) of the guide groove 18. At this position, when the head 36 is pulled upwardly away from the second body 20 (e.g., manually by a user), the antenna pole 32 is further moved upwardly in the second body 30. At this time, the contact terminal 34 is caught by a stopper 40 mounted at an end portion of the guide groove 18 so as to be prevented from being released from the guide groove 18.

The through hole 42 formed in an upper side area of the second body 20 allows the antenna pole 32 to pass therethrough, and an auxiliary antenna 44 in electrically contact with the antenna pole 32 is mounted at the through hole 42.

The auxiliary antenna 44 is disposed to be protruded to a certain length in the upward direction of the second body 20, a lower side of the auxiliary antenna 44 is threaded with the through hole 42, and a passage 46 is provided at a central portion of the auxiliary antenna 44 to allow the antenna pole 32 to pass therethrough. For instance, the auxiliary antenna 44 is fixedly mounted at the upper area of the second body 20.

The operation of the slide type mobile terminal will now be described according to the present invention.

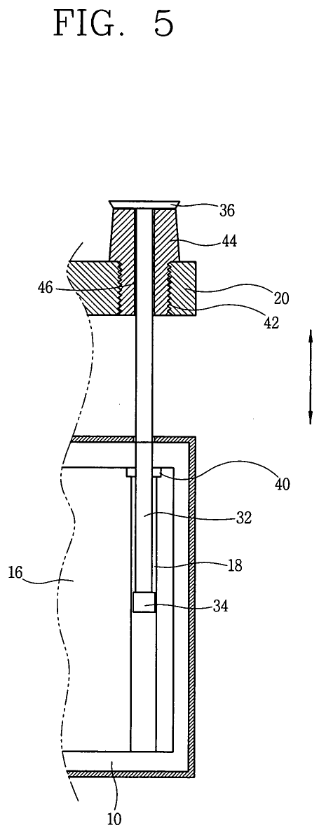

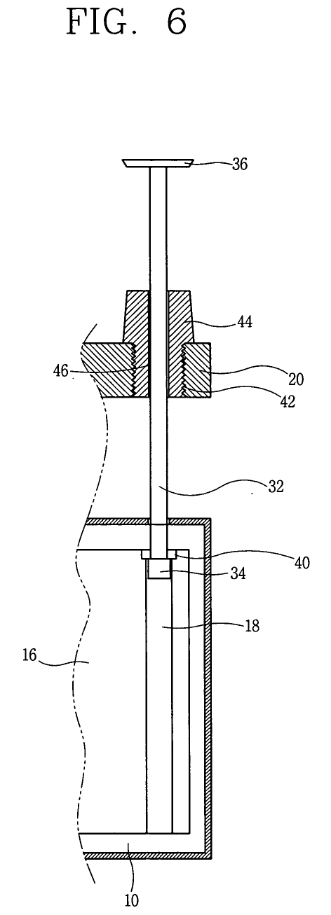

FIGS. 5 and 6 show examples of the operational states of the antenna 30 of the slide type mobile terminal of FIGS. 2-4 in accordance with the present invention.

When a user slides the second body 20 in the opening direction (e.g., upwardly), the antenna 30 mounted at the second body 20 is moved automatically due to and along with the sliding movement of the second body 20. Namely, since the head 36 of the antenna 30 is positioned at the upper end of the second body 20 and abuts the auxiliary antenna 44 fixed to the second body 20 and the antenna pole 32 is disposed to pass through the through hole 42 formed in the second body 20, when the second body 20 is slid, the antenna 30 is moved (e.g., upwardly) together with the second body 20. The amount of the movement of the antenna pole 32 can be configured to vary as desired, e.g., by controlling the amount of sliding of the second body 20. At this time, the contact terminal 34 mounted at the lower end of the antenna pole 32 is moved along the guide groove 18 formed in the PCB 16 installed in the first body 10 in a state of being electrically connected therewith.

When the sliding of the second body 20 is completed and the second body 20 is in its opened position (e.g., the key pad 12 is now exposed), then the dimensions of the mobile terminal can be configured such that the contact terminal 34 of the antenna 30 is stopped in a middle region of the guide groove 18 in the upward direction as shown in FIG. 5. But the invention is not limited thereto and the contact terminal 34 can be configured to stop at any desired location in the guide groove 18 when the sliding of the second body 20 to the opened position is completed.

At this point, the head 36 can be further pulled upwardly away from the second body 20, as shown in FIG. 6 to further enhance the reception/transmission. This may be done manually by a user. As a result, the antenna pole 32 is further moved upwardly away from the second body 32. Then, at some point, the contact terminal 34 is caught by the stopper 40 formed at the upper end of the guide groove 18, and the antenna pole 32 is not moved any further. Although the stopper 40 is located at an end of the guide groove 18, the invention is not limited thereto and the stopper 40 can be mounted at a different location of the guide groove 18 or at a different location in the mobile terminal. Other stopping mechanisms can also be used.

The auxiliary antenna 44 mounted at the second body 20 electrically contacts with the antenna pole 32.

In the manner similar to the opening operation of the mobile terminal, when the second body is slid to the closed position (e.g., downwardly by a user) to close the mobile terminal, the antenna pole 32 automatically moves in the guide groove 18 downwardly along with the second body 20 and returns to its initial position shown in FIG. 4.

Although in FIG. 2, the sliding of the second body 20 is made upwardly to place the second body (mobile terminal) in the opened position, the invention is not limited thereto and encompasses sliding of the second body in a different direction. In this case, according to the invention, the sliding of a second body to an opened position causes the antenna pole to extend out automatically to enhance reception/transmission.

As so far described, the slide type mobile terminal of the present invention has at least the following advantages.

Because the upper end portion of the antenna is positioned at the upper end of the second body and the lower end of the antenna is positioned to be movable within the PCB of the first body, when the second body is slid, the antenna is slid automatically along with the second body. Accordingly, the antenna is always and automatically prevented from being hidden by the second body, so that a null point is not generated in a radiation pattern and thus a speech quality can be enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A slide type mobile terminal comprising:
a first body having a printed circuit board (PCB) mounted therein;
a second body slidably opened/closed over the first body; and
an antenna having a first end disposed to be linearly moved in the PCB and a second end disposed at an upper side of the second body, wherein the antenna is moved along with the second body when the second body is slidably moved.

2. The mobile terminal of claim 1, wherein the first body includes a key pad to allow a user to input information therethrough, and the second body includes a liquid crystal display for displaying information.

3. The mobile terminal of claim 1, wherein the PCB of the first body includes a guide groove within which the antenna is slidably moved in electrical contact with the PCB.

4. The mobile terminal of claim 3, further comprising:
a stopper mounted at an upper end of the guide groove to prevent the antenna from being completely released from the guide groove.

5. The mobile terminal of claim 3, wherein the antenna includes:
an antenna pole with a certain length,
a contact terminal mounted at a lower end portion of the antenna pole and slidably movable in the guide groove, and
a head mounted at an upper end portion of the antenna pole and disposed at an upper end of the second body.

6. The mobile terminal of claim 5, further comprising:
a through hole formed in the second body to allow the antenna pole to pass therethrough.

7. The mobile terminal of claim 5, wherein the antenna pole has the certain length such that the antenna pole can be moved further in an upward direction of the second body after being moved in the direction that the second body is opened.

8. The mobile terminal of claim 1, further comprising:
an auxiliary antenna mounted at an upper end portion of the second body.

9. The mobile terminal of claim 8, wherein the auxiliary antenna is mounted adjacent to a through hole formed at the upper side of the second body, and has a passage at its center through which an antenna pole of the antenna having the first and second ends passes.

10. The mobile terminal of claim 9, wherein the auxiliary antenna is electrically connected with the antenna pole.

11. A mobile terminal comprising:
a first body;
a second body slidable over the first body in an opening direction to open the mobile terminal; and
an antenna configured to move automatically in an outward direction by an operation of sliding the second body over the first body in the opening direction.

12. The mobile terminal of claim 11, wherein the opening direction and the outward direction are the same.

13. The mobile terminal of claim 11, wherein one of the first and second bodies has a display screen and the other of the first and second bodies has a key pad.

14. The mobile terminal of claim 11, wherein the antenna includes:
an antenna pole movable in the outward direction within a groove of the first body; and
a contact terminal in electrical contact with an electrical circuit component in the first body.

15. The mobile terminal of claim 14, further comprising:
a stopper configured to limit the movement of the antenna pole in the outward direction.

16. The mobile terminal of claim 14, wherein the groove is disposed at a printed circuit board disposed in the first body.

17. The mobile terminal of claim 14, further comprising:
a through hole formed at an upper portion of the second body to allow the antenna pole to pass therethrough.

18. The mobile terminal of claim 11, further comprising:
an auxiliary antenna fixedly mounted at a portion of the second body.

19. The mobile terminal of claim 18, wherein the antenna configured to move in the outward direction includes a head abutting against the auxiliary antenna.

20. The mobile terminal of claim 11, wherein after the antenna moves automatically in the outward direction by the operation of sliding the second body over the first body, the antenna is movable further in the outward direction by a manual operation.
